(19) United States
(12) Patent Application Publication
(10) Pub. No.: US 2010/0171893 A1
(43) Pub. Date: Jul. 8, 2010

(54) Liquid crystal display panel with eliminating image sticking abilities and method of the same

(75) Inventor: Kuei - Wei Huang, Taipei City (TW)

Correspondence Address: BACON & THOMAS, PLLC, 625 SLATERS LANE, FOURTH FLOOR, ALEXANDRIA, VA, 22314-1176, US

(73) Assignee: CHUNGHWA PICTURE TUBES, LTD., Taoyuan County (TW)

(21) Appl. No.: 12/453,015

(22) Filed: Apr. 28, 2009

(30) Foreign Application Priority Data
Jan. 5, 2009 (TW) 098100086

(51) Int. Cl. G02F 1/1343

(52) U.S. Cl. 349/38

(57) ABSTRACT

The present invention provides a liquid crystal display panel with eliminating image sticking abilities. The liquid crystal display panel includes a main thin film transistor disposed on a substrate which includes a first gate coupled to a corresponding scanning line, a first source coupled to a corresponding data line. A sub thin film transistor disposed on the substrate includes a second gate coupled to pro-scanning line of the corresponding scanning line, a second source coupled to the adjacent data line of the corresponding data line. The main thin film transistor and the sub thin film transistor are disposed on a pixel.

### BACKGROUND

1. Field of the Invention

This invention relates to a liquid crystal display panel, and more particularly to a liquid crystal display panel with eliminating image sticking abilities, wherein a sub thin film transistor is disposed on a pixel, which a gate of the sub thin film transistor is coupled to pro-scanning line of the corresponding scanning line, and a source of the sub thin film transistor is coupled to the adjacent data line for facilitating dissipating charges accumulated in the pixel to effectively eliminate the image sticking.

2. Description of the Prior Art

With the development of the optical technology and the semiconductor technology, a liquid crystal display device is generally applied for consumer displays. In general, the liquid crystal display device has the advantages including high-definition, small volume, light weight, low driving voltage, low power dissipation and more applications, and thereby to be as main technology of a display device to replace conventional cathode-ray tube displays.

In general, a liquid crystal display device includes two substrates, liquid crystals sealed therebetween, pixel electrode, thin film transistor configured on one substrate, color filter film corresponding to each of the pixel electrodes and common electrode disposed on the other substrate. The color filter film consists of Red, Green and Blue three color filter films, and each of the pixels has one of the three color filter films formed thereon. Red, Green and Blue pixel are disposed adjacent together to form one pixel.

Moreover, multi-domain vertical alignment (MVA) technology has been developed with better viewing angle, which separates a sub-pixel into 4 domains, and has been the most applicable mode applying to LCD-TVs. Liquid crystal display devices made by multi-domain vertical alignment (MVA) technology have the advantages including high contrast, wide viewing angle and large size compatible, but color washout at large viewing angle and slow response time are the remained two issues that will degrade the image quality of MVA mode. For reducing color washout, the most efficient way is to increase the domains in a sub-pixel from 4 to 8 or more. Capacitance coupling type (C-C type), dual data or dual gate type (T-T type) and common voltage swinging (Com-swing) technologies were proposed to generate 8 domains. However, both T-T type and Com-swing technology required extra ICs and electronic components that will increase the cost. C-C type does not increase the cost but will induce serious image-sticking due to the floating electrode of the self-coupled capacitance.

Referring to the left side of FIG. 1, it shows a conventional C-C type pixel design which includes two pixel regions 60 and 61 by utilizing metallized capacitance induction method, wherein data signal (for example 5 voltage) is directly input into the pixel region 60 to create the same voltage with the data signal in Clc-1 capacitance, and Cx capacitance in the pixel region 61 is induced by Clc-2 capacitance in series connection with Cx capacitance such that Clc-1 capacitance has different charging ratio with Clc-2 capacitance (such as Clc-1 capacitance 5 voltage, Clc-2 capacitance 3 voltage), and thereby the pixel region 60 has different brightness with that of the pixel region 61. Alternatively, referring to the right side of FIG. 1, it shows a C-C type pixel circuit. C-C type will induce serious image-sticking due to the residual charge of the induced metallic layer. Referring to FIG. 2, it shows checker board image, wherein the left side image in the regions 65 and 66 are transferred as the right side image in the regions 66 and 67 respectively after burn-in testing. Accordingly, the right side image in the region 67 becomes gray level image and un-recovering to the original image of the region 65.

Additional refresh technology was proposed for Advanced-MVA (A-MVA) mode, referring to Y. P. Huang, et al, “Additional refresh technology (ART) of Advanced-MVA mode for High Quality LCDs”, which divided a sub-pixel into main-region and sub-region to yield 8 domains, and the pixel circuit shown in FIG. 3. The additional refresh technology (ART) generates a 8-domains sub-pixel with self-overdriving function thus can not only reduce the color washout but also shorten the response time. It utilized an additional TFT (Sub-TFT) 81 disposed in the pixel circuit, which gate coupled to gate line of the pixel, source coupled to electrode of the sub-region and drain coupled to data line of the pixel. The Sub-TFT 81 has different width/length (W/L) and charging ratio to the main-TFT 80 to refresh (recharge) the voltage of sub-region (Vsub) in each frame. Additionally, due to the recharge (refresh) of sub-TFT in each frame, the ion will not accumulate on the electrode thus can suppress the image-sticking issue. Referring to FIG. 3, Cst_{sub} and Clc_{sub} is the storage and LC capacitance of the sub-region, and Cx is the coupling capacitance. Vmain is the voltage of the main-region. Isub is the charging current of the sub-TFT 81. Therefore, by simply modifying Cx and Isub from pixel layout, the Vsub can be optimized for reducing the color washout without any extra high cost components. To summarized, the additional refresh technology (ART) is utilized by disposing an additional sub-TFT on pixel circuit to provide tiny AC signal to electrode of the sub-region thus can prevent the residual charges accumulation.

From above mentioned, additional refresh technology (ART) of Advanced-MVA (A-MVA) mode is utilized by adding a sub-TFT into pixel circuit, and gate of the sub-TFT coupled to gate line of the pixel thus the accumulated charge on electrode of sub-region can be dissipated from the gate line, and wherein the main-TFT and the sub-TFT use the identical gate line and data line. The accumulated charges on electrode of sub-region can be dissipated when gate of the sub-TFT is turned on. In other words, the recharge (refresh) of sub-pixel is then performed after residual charges removed, and thereby increasing display time of a liquid crystal.

In view of the aforementioned drawbacks, the present invention provides an improved method and apparatus for suppress image sticking to increase a liquid crystal display performance.

### SUMMARY OF THE INVENTION

To overcome the prior art drawbacks, the present invention provides a liquid crystal display panel with some domains pixel to eliminate the image sticking, which utilizes a thin film transistor disposed on a sub-pixel, wherein the thin film transistor is coupled to pro-scanning line for facilitating charges accumulated in the sub-pixel dissipating from adjacent data line to effectively eliminate the image sticking.

Another objective of the present invention is to provide a display method of a liquid crystal display panel to reduce display time of liquid crystals.

The present invention provides a liquid crystal display panel which includes a main thin film transistor disposed on a substrate which includes a first gate coupled to a corresponding scanning line, a first source coupled to a corresponding data line. A sub thin film transistor disposed on the substrate includes a second gate coupled to pro-scanning line of the corresponding scanning line, a second source coupled to the adjacent data line of the corresponding data line. The main thin film transistor and the sub thin film transistor are disposed on an identical pixel.

The another aspect of the present invention is a method for eliminating image sticking of a liquid crystal display panel, comprising disposing a main thin film transistor and a sub thin film transistor on an identical pixel. The next step is coupling a corresponding scanning line to a first gate of the main thin film transistor, coupling a corresponding data line to a first source of the main thin film transistor. Subsequently, pro-scanning line is coupled to a second gate of the sub thin film transistor, coupling adjacent data line to a second source of the sub thin film transistor to eliminate the image sticking.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic diagram of a pixel circuit of C-C type liquid crystal display panel according to the prior art.

FIG. 2 is schematic diagram of checker board image of before/after burn-in testing.

FIG. 3 is a schematic diagram of a pixel circuit of Additional refresh technology (ART) of Advanced-MVA mode liquid crystal display panel according to the prior art.

FIG. 4 is a schematic diagram of a pixel circuit of a liquid crystal display panel according to the present invention.

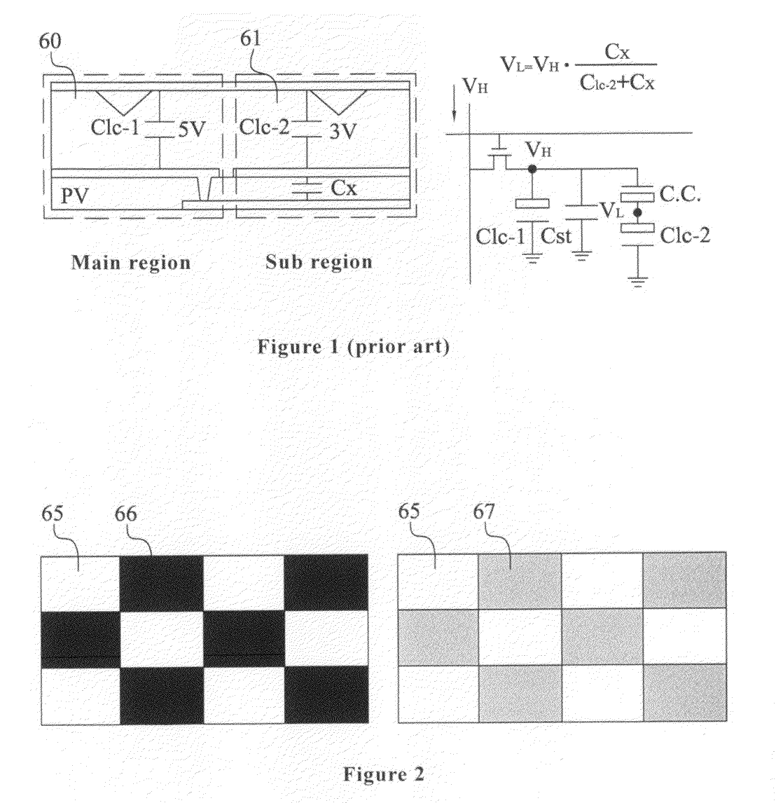

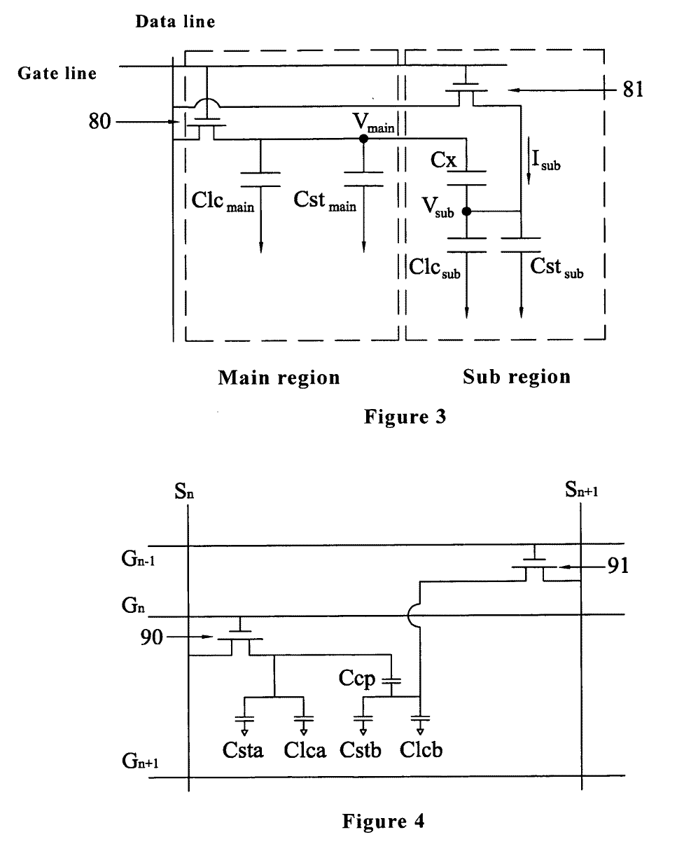

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

To overcome the prior art drawbacks, the present invention provides a liquid crystal display panel with 8-domains pixel which utilizes a thin film transistor disposed on a sub-pixel, wherein the thin film transistor is coupled to pro-scanning line, and thus charges accumulated in the sub-pixel may be dissipated from adjacent data line to effectively eliminate the image sticking.

FIG. 4 shows a pixel circuit of a liquid crystal display panel of the present invention. In some embodiments of the invention, the identical components will not be described or explained repeatedly. Moreover, the embodiment of the present invention is expressly not limited to a liquid crystal display panel made by the present invention. A liquid crystal display panel includes first substrate and second substrate corresponding disposed for each other, liquid crystals disposed between the first substrate and second substrate.

FIG. 4 shows a pixel circuit of a liquid crystal display panel of the present invention to yield 8-domain pixel. In the FIG. 4, gate of main thin film transistor 90 in main-region is coupled to n-th scanning line Gn, a source of the main thin film transistor 90 is coupled to n-th data line Sn, and a drain of the main thin film transistor 90 is coupled to Csta and Clca. Clca and Clcb represents as a capacitance (liquid capacitance) between sub-pixel electrode and common electrode of main-region and sub-region respectively. Csta and Cstb represents as a storage capacitance of the main-region and the sub-region respectively. Ccp represents as a coupling capacitance (auxiliary capacitance), such as coupling capacitance between data line and pixel electrode. The storage capacitance Csta is coupled to a drain of the main thin film transistor 90, and the storage capacitance Cstb is coupled to a drain of the sub thin film transistor 91. The liquid capacitance Clca is coupled to a drain of the main thin film transistor 90, and the liquid capacitance Clcb is coupled to a drain of the sub thin film transistor 91. The auxiliary capacitance Ccp is coupled to the liquid capacitance Clcb and the storage capacitance Cstb. Ccp capacitance is induced by Clca capacitance in series connection with Ccp capacitance such that Clca capacitance has different charging ratio with Clcb capacitance.

In the pixel circuit, the Sub-TFT 91 has different width/length (W/L) and charging ratio to the main-TFT 90. Gtae of the Sub-TFT 91 is coupled to (n−1)-th pro-scanning line Gn-1, and source of the Sub-TFT 91 is coupled to (n+1)-th adjacent data line Sn+1 such that drain of the Sub-TFT 91 is coupled to Cstb and Clcb. The Sub-TFT 91 and the main-TFT 90 are configured on an identical pixel. The above-mentioned n-th scanning line Gn, n-th data line Sn, (n−1)-th pro-scanning line Gn−1 and (n+1)-th data line Sn+1 are disposed on the first substrate. The first substrate is active component array substrate, and material of the first substrate includes glass, quartz or flexible material. The second substrate is color filter substrate corresponding to the active component array substrate. Therefore, liquid crystals are disposed between color filter substrate and the active component array substrate. Material of the color filter substrate includes glass, quartz or flexible material.

From above description, in the present invention, the residual charges remains on the sub-region, which utilizes the sub TFT 91 coupled to the different Gn—1 scanning line to turn on/off the sub TFT 91, and by activating the adjacent Sn+1 gate line for removing the residual charges to suppress image sticking, and further recharging the pixel. It can avoid the issue of the prior art that the recharge of sub-pixel needs to be performed after residual charges removed. The residual charges are removed by neutralizing positive charges and negative charges of different region and components.

Therefore, in the prior art, the main TFT and the sub TFT are coupled to the identical scanning line and data line. The storage charges of the main TFT and the sub TFT are simultaneously dissipated as turning on their gate thus the recharge of sub-pixel needs to be performed after residual charges removed. The main technical features of the present invention is that the residual charges remains on the sub-region, which utilizes the sub TFT coupled to pro-scanning line and adjacent data line to turn on the sub TFT before recharging the pixel, and by activating the adjacent gate line for removing the residual charges, and then recharging the pixel. Therefore, it is without the step of removing the residual charges.

The above description of the invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A liquid crystal display panel with a first substrate, comprising:
a main thin film transistor disposed on said first substrate with a first gate coupled to a corresponding scanning line and a first source coupled to a corresponding data line;
a sub thin film transistor disposed on said first substrate with a second gate coupled to pro-scanning line of said corresponding scanning line and a second source coupled to the adjacent data line of said corresponding data line;
wherein said main thin film transistor and said sub thin film transistor are disposed on an identical pixel;
a first storage capacitance coupled to first drain of said main thin film transistor and a second storage capacitance coupled to second drain of said sub thin film transistor; and
a first liquid capacitance coupled to first drain of said main thin film transistor and a second liquid capacitance coupled to second drain of said sub thin film transistor.

2. The liquid crystal display panel of claim 1, further comprising an auxiliary capacitance coupled to said second storage capacitance.

3. The liquid crystal display panel of claim 1, further comprising an auxiliary capacitance coupled to said second liquid capacitance.

4. The liquid crystal display panel of claim 1, wherein said first substrate is active component array substrate.

5. The liquid crystal display panel of claim 1, further comprising a second substrate which is a color filter substrate corresponding to said first substrate.

6. The liquid crystal display panel of claim 1, further comprising liquid crystals disposed between said first substrate and said second substrate.

7. A method for eliminating image sticking of a liquid crystal display panel, comprising:
disposing a main thin film transistor and a sub thin film transistor on an identical pixel;
coupling a corresponding scanning line to a first gate of said main thin film transistor, coupling a corresponding data line to a first source of said main thin film transistor; and
coupling pro-scanning line to a second gate of said sub thin film transistor, coupling adjacent data line to a second source of said sub thin film transistor to eliminate said image sticking.
